(19) United States
(12) Patent Application Publication
(10) Pub. No.: US 2026/0023461 A1
(43) Pub. Date: Jan. 22, 2026

(54) APPLICATION CREATION

(71) Applicant: Beijing Zitiao Network Technology Co., Ltd., Beijing (CN)

(72) Inventors: Yibo LI, Beijing (CN); Hanlin HE, Beijing (CN); Yuyang PAN, Beijing (CN)

(21) Appl. No.: 18/937,781

(22) Filed: Nov. 5, 2024

(30) Foreign Application Priority Data
Jul. 16, 2024 (CN) 202410955318.9

(51) Int. Cl. G06F 3/0484; G06F 3/0482; G06F 8/71

(52) U.S. Cl. CPC G06F 3/0484; G06F 3/0482; G06F 8/71

(57) ABSTRACT

Embodiments of the present disclosure relate to a method, apparatus and device for creating an application, and a storage medium. The method proposed herein includes: obtaining application configuration information, application configuration information includes interactive control information about a target interactive scene, wherein the interactive control information is used to construct a target processing entity corresponding to the target interactive scene, causing the target processing entity to manage, based on the interactive control information, an interaction process of a set of interactive objects participating in the target interactive scene, the interactive control information indicates at least one workflow associated with the target processing entity; and creating the target application based on the application configuration information. In this way, embodiments of the disclosure can provide for managing an interaction process by calling a workflow in an interactive scene, thereby improving the management efficiency of the interactive scene.

### CROSS REFERENCE

The present application claims priority to Chinese Patent Application 202410955318.9, filed on Jul. 16, 2024 and entitled “METHOD AND APPARATUS FOR CREATING APPLICATION, DEVICE AND STORAGE MEDIUM”, the entirety of which is incorporated herein by reference.

### FIELD

Example embodiments of the present disclosure generally relate to the field of computers, and more particularly, to creating an application.

### BACKGROUND

With the development of computer technology, people may create and publish various types of applications through different platforms. For example, with the development of machine learning technologies, people can quickly create an application by configuring parameters of the application, such as models used by the application, available plug-ins, and so on.

### SUMMARY

In a first aspect of the present disclosure, a method for creating an application is provided. The method includes: obtaining application configuration information, the application configuration information including interactive control information about a target interactive scene, where the interactive control information is configured to construct a target processing entity corresponding to the target interactive scene, such that the target processing entity manages, based on the interactive control information, an interaction process for a set of interactive objects participating in the target interactive scene, the interactive control information indicates at least one workflow associated with the target processing entity; and creating a target application based on the application configuration information.

In a second aspect of the present disclosure, an apparatus for creating an application is provided. The apparatus includes: an obtaining module configured to obtain application configuration information, the application configuration information including interactive control information about a target interactive scene, where the interactive control information is configured to construct a target processing entity corresponding to the target interactive scene, such that the target processing entity manages, based on the interactive control information, an interaction process for a set of interactive objects participating in the target interactive scene, and the interactive control information indicates at least one workflow associated with the target processing entity; and a creating module configured to create a target application based on the application configuration information.

In a third aspect of the present disclosure, there is provided an electronic device, the device including at least one processing unit; and at least one memory, the at least one memory being coupled to the at least one processing unit and storing instructions for execution by the at least one processing unit. The instructions, when executed by the at least one processing unit, cause the device to perform operations that implement the method of the first aspect.

In a fourth aspect of the present disclosure, a computer readable storage medium is provided. The computer readable storage medium stores a computer program thereon, and the computer program is executable by a processor to perform operations that implement the method of the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, where:

FIG. 1 illustrates a schematic diagram of an example environment.

FIG. 2 illustrates a flowchart of an example process for creating an application.

FIGS. 3A-B illustrate example interfaces.

FIG. 4 illustrates a schematic structural block diagram of an example apparatus for creating an application.

FIG. 5 illustrates a block diagram of an example electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as open-ended including, that is, “including but not limited to”. The term “based on” should be read as “based at least in part on.” The term “one embodiment” or “the embodiment” should be read as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

Embodiments of the present disclosure may relate to data, acquisition and/or use of data, etc. by a user, all following respective legal regulations and related regulations. In embodiments of the present disclosure, all data collection, acquisition, processing, processing, forwarding, use, and the like, are made with user knowledge and confirmation. Accordingly, when implementing the embodiments of the present disclosure, the user should be informed of the types of data or information that may be involved, a usage range, a usage scene, and the like in an appropriate manner according to relevant legal regulations, and the authorization of the user is obtained. The specific informing and/or authorization manner may vary according to actual situations and application scenes, and the scope of the present disclosure is not limited in this aspect.

In the present description and the embodiments, solutions, if personal information processing is involved, are performed on the basis of legitimacy (for example, the consent of the personal information body is obtained, or necessary for fulfillment of a contract, etc.), and is performed only within a specified range or an agreed range. The user rejects personal information other than the necessary information required for processing the basic function, and the use of the basic function by the user is not affected.

Conventionally, a user configures a model, a plug-in, and the like used by an application to quickly create an application, for example, a robot program (bot). However, the application created by the user typically only supports the user's interaction with a single intelligent volume or bot. This makes the interactive scenes that can be provided by user-created applications very limited.

Embodiments of the present disclosure propose a solution for creating an application. According to the solution, application configuration information may be obtained, the application configuration information includes interactive control information about a target interactive scene, where the interactive control information is configured for constructing a target processing entity corresponding to the target interactive scene, such that the target processing entity manages, based on the interactive control information, an interaction process for a set of interactive objects participating in the target interactive scene, and the interactive control information indicates at least one workflow associated with the target processing entity. Further, a target application may be created based on the application configuration information.

In this way, the embodiments of the present disclosure can provide a target control entity to manage an interaction process in a target interactive scene by calling a workflow, thereby improving the management efficiency of the interaction process and reducing the development costs of an application.

Various example implementations of the solution are described in further detail below with reference to the accompanying drawings.

### Example Environment

FIG. 1 shows a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 can be any suitable type of application for interface interaction, examples of which may include, but are not limited to, a development application or other suitable application that supports workflow creation. A user 140 may interact with application 120 via electronic device 110 and/or an attached device thereof.

In the environment 100 of FIG. 1, if the application 120 is active, the electronic device 110 may present an interface 150 through the application 120 to support creation of the application.

In some embodiments, the electronic device 110 communicates with server 130 to enable the provision of services to application 120. The electronic device 110 may be any suitable type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, and a Personal Communication System, a PCS) device, personal navigation device, personal digital assistant (PDA), audio/video player, digital camera/camcorder, positioning device, television receiver, radio broadcast receiver, electronic book device, game device, or any combination of the foregoing, including accessories and peripherals for these devices, or any combination thereof. In some embodiments, electronic device 110 can also support any type of interface to a user (such as a “wearable” circuit or the like).

The server 130 may be an independent physical server, may also be a server cluster or a distributed system formed by a plurality of physical servers, and may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, etc. The server 130 may provide background services for the virtual scene-enabled application 120 in the electronic device 110.

A communication connection may be established between the server 130 and the electronic device 110. The communication connection may be established in a wired manner or a wireless manner. Communication connections may include, but are not limited to, Bluetooth connections, mobile network connections, Universal Serial Bus (USB) connections, Wireless Fidelity (Wi-Fi) connections, and the like, to which embodiments of the present disclosure are not limited. In embodiments of the present disclosure, the server 130 and the electronic device 110 may enable signaling interaction through a communication connection therebetween.

It should be understood that the structure and function of the various elements in environment 100 are described for exemplary purposes only, and are not intended to imply any limitation on the scope of the disclosure.

Some example embodiments of the present disclosure will be described below with continued reference to the accompanying drawings.

### Example Process for Application Creation

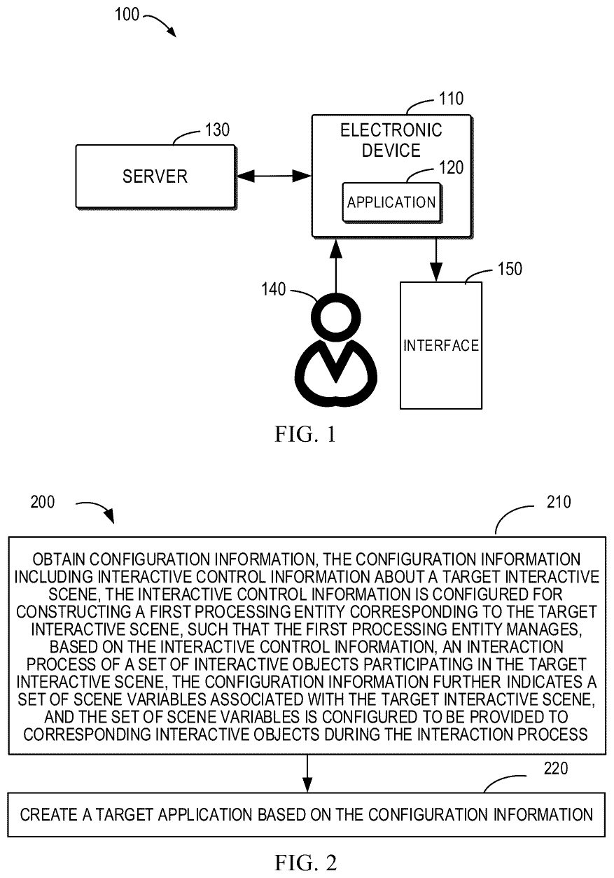

FIG. 2 illustrates a flowchart of a process 200 for creating an application according to some embodiments of the disclosure. The process 200 may be implemented at the electronic device 110. The process 200 is described below with reference to FIG. 1.

At block 210, the electronic device 110 obtains application configuration information. The application configuration information includes interactive control information about a target interactive scene. The interactive control information is configured to construct a target processing entity corresponding to the target interactive scene such that the target processing entity manages, based on the interactive control information, an interaction process for a set of interactive objects participating in the target interactive scene. Additionally, the interactive control information indicates at least one workflow associated with the target processing entity.

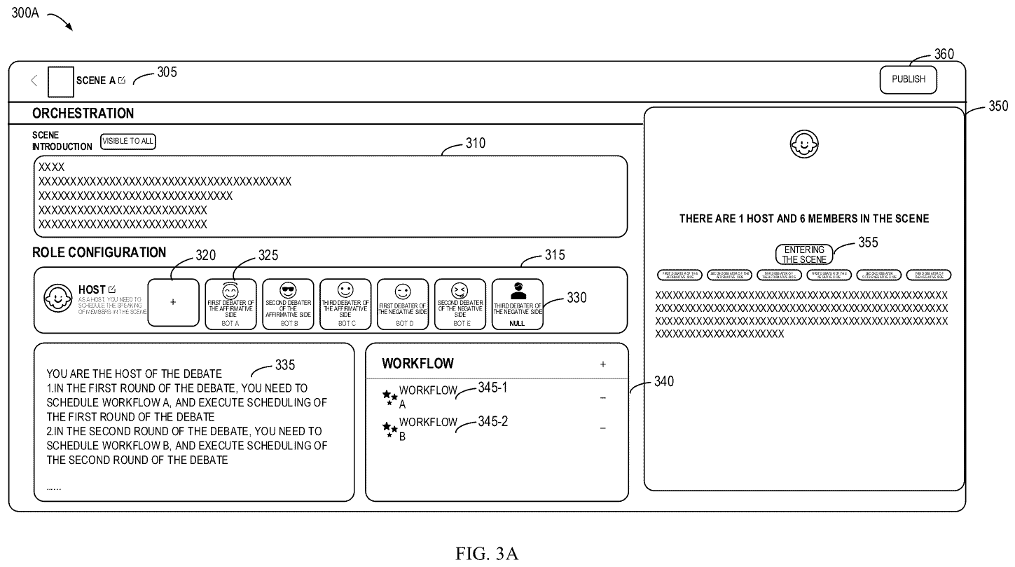

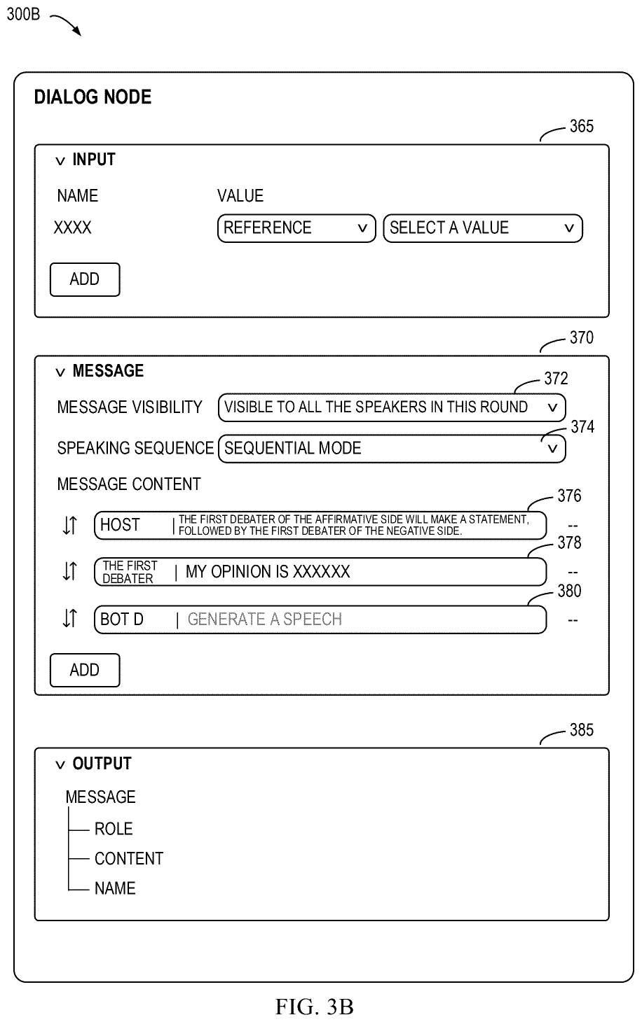

The specific process of obtaining the application configuration information will be described further below in conjunction with FIGS. 3A-3B. FIGS. 3A-3B illustrate example interfaces according to some embodiments of the disclosure.

As shown in FIG. 3A, the electronic device 110 may present a configuration interface 300A as shown in FIG. 3A, based on a user's request for application creation. The configuration interface 300A can be used to receive application configuration information to create an application associated with a target interactive scene.

By way of example, the electronic device 110 can present the configuration interface 300A based on an application identifier or a scene identifier (e.g., Scene A) 305 input by the user. As shown in FIG. 3A, the configuration interface 300A can include an input control 310 for obtaining scene description information about a target interactive scene.

As an example, such scene description information may include a piece of descriptive text for describing an interactive scene to be created. Such scene description information may be public information visible to an interactive object participating in the interactive scene. In a case where the interactive object includes a predetermined processing entity (e.g., an intelligent agent, or other application such as a bot), such scene description information may be provided to a corresponding predetermined processing entity for controlling interaction of the predetermined processing entity in the interactive scene.

Taking a debate scene shown in FIG. 3A as an example, such scene description information may include, for example, a topic of the debate, a point of view of an affirmative side, a point of view of a negative side, and the like.

In some embodiments, as shown in FIG. 3A, the configuration interface 300A may further include a role configuration control 315 for obtaining a set of predetermined roles associated with the target interactive scene.

As shown in FIG. 3A, the electronic device 110 may allow the user to add multiple predetermined roles in an interactive scene. Taking a debate scene as an example, the user may add roles such as a first to a third debater of the affirmative side and a first to a third debater of the negative side.

In the interaction process, a set of interactive objects participating in the interactive scene are allocated to corresponding predetermined roles. As will be described below, such interactive objects may, for example, include user objects or may also include processing entities based on a configuration, such as an intelligent body or a bot, etc.

As shown in FIG. 3A, the electronic device 110 may provide an adding portal 320 for initiating a request for adding a role. After receiving a selection of the adding portal 320, the electronic device 110 may obtain role description information regarding the role to be added.

Additionally, the electronic device 110 may also determine visibility information for the role. The visibility information may be used to describe whether role information corresponding to the role is visible to other roles. Taking the debate scene as an example, role information of each interactive object is visible to other objects. Therefore, the user may, for example, set “First debater of the affirmative side” to be visible to all the roles.

As another example, in some interactive scenes, some interactive objects need to hide their role information at a particular stage. Accordingly, the user can set the visibility information of the role, for example, to be visible only to the host (as the processing entity for scheduling which will be described below).

Further, the electronic device 110 may also allow the user to associate the role with the predetermined processing entity or to associate the role with a null interactive object. The electronic device 110 may, for example, allow the user to select a predetermined processing entity (e.g., a BOT A) and associate the processing entity to the added role (e.g., the first debater of the affirmative side). As an example, the electronic device 110 may present a set of candidate processing entities that the user has permission to add (e.g., a set of Bots created by the user or to which the user has permission to access), and further may select a particular processing entity to associate to the role.

As an example, the electronic device 110 may also allow the replacing of an associated processing entity by the user. Further, the electronic device 110 can allow editing of an identifier (for example, a nickname) of the processing entity in the target interactive scene; and may edit a descriptive text regarding the processing entity.

In some embodiments, such identifiers and descriptive text may be provided to other processing entities in the interactive scene. For example, the identifier and descriptive text may be provided to a processing entity associated with other roles, or a specific processing entity for scheduling, etc.

With continued reference to FIG. 3A, the electronic device 110 may display, in the role configuration controls 315, the role indication elements corresponding to the added one or more predetermined roles, e.g., the role indication element 325 and the role indication element 330.

As shown in FIG. 3A, the role (e.g., the first debater of the affirmative side) corresponding to the role indication element 325 may be associated with a designated processing entity. Accordingly, the role indication element 325 may display an image identifier corresponding to the processing entity (e.g., an image identifier of a Bot), a name of the role and a nickname of the associated processing entity in the interactive scene, etc.

As another example, the role (e.g., the third debater of the negative side) corresponding to the role indication element 330 is associated with a null interactive object. In some scenes, the association with the null interactive object may indicate that the role is not provided with a corresponding predetermined processing entity. That is, other users may designate to participate as a user and associate with the role during an interaction with the target application, or other processing entities may be selected and associated with the role.

In particular, if a specific role is associated with a null interactive object, the electronic device 110 may further control the target application to provide an object configuration window for configuring the target interactive object corresponding to the role. For example, the electronic device 110 may set the user object as the target interactive object based on the user's configuration operation, or may also set a particular processing entity indicated by the user as the target interactive object.

For example, where the role of “the third debater of the negative side” is associated with a null interactive object, the user may start the application and select himself or a particular processing entity (e.g., bot) as the role of “the third debater of the negative side” to participate in the interactive scene.

Accordingly, as shown in FIG. 3A, the role indication element 330 may display corresponding object information (e.g., “null”) to indicate that it is associated with a null interactive object. In addition, the role indication element 330 may display a predetermined image content.

Further, as shown in FIG. 3A, the configuration interface 300A may further include an input control 335 for obtaining interactive control information. In some embodiments, the interactive control information may include a piece of text that describes an interaction rule and/or a control logic for the interactive scene.

In some embodiments, as illustrated in FIG. 3A, the configuration interface 300A may further include a workflow configuration control 340 for configuring one or more workflows associated with the target processing entity.

As shown in FIG. 3A, for example, the target processing entity may be associated with workflow A 345-1 and workflow B 345-2 (individually or collectively referred to as workflows 345). In some embodiments, the interactive control information received via the input controls 335 may, for example, indicate a workflow 345 associated with the target processing entity.

Using FIG. 3A as an example, the interactive control information may instruct the target processing entity to call the workflow A 345-1 in a first round of the debate and call the workflow B 345-2 in a second round of the debate.

In this way, the target processing entity may manage the interaction process in the target interactive scene by way of calling a workflow, thereby improving the control reliability of the interaction process.

In some embodiments, the workflow 345 may be specific to the created target interactive scene (e.g., Scene A). For example, when creating other interactive scenes, the user cannot view, for example, workflows corresponding to the other scenes.

In some embodiments, the electronic device 110 may receive a request for viewing, e.g., via a workflow configuration control 340, and may present a set of candidate workflows associated with the current interactive scene accordingly. Further, the electronic device 110 can receive a selection of one or more workflows from a set of candidate workflows, and can accordingly associate the selected workflow to the target processing entity.

In some embodiments, the electronic device 110 may also receive a creating request, e.g., via the workflow configuration control 340, and may present a workflow creation page accordingly. Further, the electronic device 110 may create a workflow associated with the target interactive scene based on the workflow creation page, and may associate the workflow to the target processing entity.

In some embodiments, the workflow 345 for the target interactive scene may include a plurality of nodes, and the requests may be processed sequentially based on connections between the plurality of nodes.

In some embodiments, the workflow 345 may include a dialog node for creating a speaking task for triggering at least one speaker to provide a corresponding message in the target interactive scene. The at least one speaker may include a target processing entity in the target interactive scene and/or one or more interactive objects participating in the target interactive scene.

FIG. 3B illustrates a schematic view of a speaking node 300B according to some embodiments of the present disclosure. As illustrated in FIG. 3B, the electronic device 110 may, for example, allow the user to add a speaking node in the workflow 345 for triggering a speaking task in the target interactive scene.

Specifically, as shown in FIG. 3B, the speaking node 300B may include a configuration control 365 for configuring input parameters of the speaking node 300B. In some embodiments, such input parameters may be configured by referencing a preceding node of the speaking node 300B. The preceding node may include any appropriate preceding node associated with the speaking node 300B without requiring it to be directly connected to the speaking node 300B.

In some embodiments, the speaking node 300B may also include a configuration control 370. The configuration control 370 may be used to configure one or more parameters related to the speaking task. As shown in FIG. 3B, the electronic device 110 may determine, via the configuration control 370, a visible range 372 for the message provided by the at least one speaker.

In some embodiments, such visible range 372 may include the following predetermined modes: visible to all interactive objects, visible to all speakers, visible to a message recipient, visible to a particular character, etc.

In some embodiments, the electronic device 110 may also determine, via the configuration controls 370, a sequential mode 374 of the plurality of speakers, where the sequential mode 374 may indicate the speaking sequence of the plurality of speakers.

In some embodiments, the sequential mode 374 may include, but is not limited to: a first sequential mode indicating that the plurality of speakers speak sequentially according to a target sequence configured via the dialog node; a second sequential mode indicating that the plurality of speakers speak sequentially according to a random sequence; and a third sequential mode indicating that the plurality of speakers speak in parallel, etc.

Further, the electronic device 110 may also obtain identity configuration information corresponding to the at least one speaker via the configuration control 370. The identity configuration information may indicate, for example, that the utterance is to be made by the target processing entity or a particular interactive object.

As shown in FIG. 3B, the electronic device 110 may configure a content item 376 via the configuration control 370 to indicate that the speaking is made by a role “Host”. For example, the user may indicate that the speaker is the target processing entity by selecting the role “Host”.

Similarly, the electronic device 110 may configure a content item 378 via the configuration control 370 to indicate that the speaking is made by the role “First debater of the affirmative side”. For example, the user may indicate that the speaker is the processing entity BOT A by selecting the role “First debater of the affirmative side”.

In some embodiments, the electronic device 110 may also configure a content item 380 via the configuration control 370 to indicate that the speaking is made by the processing entity “BOT D”. For example, the user may indicate that the speaker is the processing entity “BOT D” by designating the nickname “BOT D” of the speaker.

In some embodiments, the electronic device 110 may also support indicating the speaker, for example, by selecting an identity variable defined in the workflow. Such identity variables may be used to determine at least one interactive object in the target interactive scene.

As an example, the workflow 345 may include other nodes to determine a value for the identity variable based on the interaction information in the target interactive scene, and may in turn provide the value to the dialog node 300B to indicate that the interactive object corresponding to the value is the speaker in this round of the debate.

Further, as shown in FIG. 3B, the electronic device 110 may further obtain message configuration information of at least one speaker through the configuration control 370, where the message configuration information may indicate content of a target message provided by the at least one speaker.

Using FIG. 3B as an example, the electronic device 110 may, for example, allow inputting of content to be provided by a speaker directly through the configuration control 370. For example, the content items 376 and 378 may include message content input by the user via the configuration control 370.

In some embodiments, the electronic device 110 may also allow configuring the speaker to generate target messages to be provided. In particular, the electronic device 110 may, for example, receive a selection of a message providing mode corresponding to a particular speaker.

In some embodiments, such a message providing mode may include, for example, a first providing mode and a second providing mode. The first providing mode may indicate that the at least one speaker generates the target message; and the second providing mode may indicate that the at least one speaker provides the target message configured via the dialog node.

In some embodiments, the target processing entity may, for example, only allow the second providing mode. That is, when the speaker is the target processing entity, the user needs to configure the content that the target processing entity needs to provide.

In some embodiments, the role associated with the null interactive object may, for example, only support the first providing mode. In other words, when a certain character is not associated with a predetermined processing entity, the speaker corresponding to the character is allowed to speak only in a generation mode. It should be understood that, if the role is associated with the user object, the message content input by the user object may be obtained.

In some embodiments, only the first providing mode may be supported by the speaker defined by the identity variable. That is, if a certain speaker is defined by selecting a corresponding identity variable, the speaker will only support the first providing mode.

Using FIG. 3B as an example, the processing entity “BOT D” may correspond to the first providing mode. The content item 380 may indicate that the processing entity “BOT D” may generate a corresponding message in this round of the debate.

In some scenarios, the sequential mode 374 is a first sequence mode, in which a plurality of speakers speak sequentially according to a target sequence configured by the dialog nodes. Accordingly, the electronic device 110 may also adjust, e.g., based on a received configuration operation, a display sequence of a plurality of content items (e.g., the content item 376, the content item 378, and the content item 380) corresponding to the plurality of the speakers in the dialog node 300B, to determine the target sequence of the speakers.

For example, the user may change the display sequence of the content item 376, the content item 378, and the content item 380 in the dialog node 300B by dragging the content item or interaction elements in front of it, and thereby adjusting the speaking sequence of the “Host”, “First debater of the affirmative side” and “BOT D”.

In some embodiments, as illustrated in FIG. 3B, the dialog node 300B also includes a configuration control 385 for configuring output content of the dialog node 300B. As an example, the dialog node 300B may be configured to output first content in accordance with the first format shown by the configuration control 385.

In some embodiments, the first content output by the dialog node 300B includes at least one of: a role of the at least one speaker; an identifier (for example, a nickname) of the at least one speaker; and message content provided by the at least one speaker.

In some embodiments, the workflow 345 may also include a start node. Unlike the start nodes of other types of workflows, the start node in the workflow 345 for the target interactive scene may, for example, be configured to output the second content in a configured second format. In some embodiments, the second content is used to describe a set of interactive objects in the target interactive scene.

As an example, the start node may define a set of identity variables, may obtain descriptive information (e.g., role configuration information) associated with the target interactive scene, and then determine the values of the set of identity variables. Accordingly, the start node may construct the second content based on the values of the set of identity variables and may provide the second content to other appropriate nodes in the workflow 345.

In some embodiments, the workflow 345 may also include a termination node. In some embodiments, the end node is configured to generate a control message for terminating the target interactive scene. For example, when the termination node in the workflow 345 is triggered to be executed, the workflow 345 may return a control message to control the termination of the target interactive scene.

The workflow configured in the foregoing manner can better meet the scheduling requirements of the interaction scenario, thereby improving the scheduling efficiency of the interaction process.

In some embodiments, such interactive control information may be provided for creating the target processing entity (i.e., the host role mentioned above) in the interactive scene. In some embodiments, the target processing entity may be configured to manage the interaction process of the plurality of interactive objects in the interactive scene.

Continuing to take a debate scenario as an example, the interactive control information may describe, for example, a procedure of the whole debate process, a speaking sequence of each role, content that needs to be output by the host role, and the like.

In some embodiments, such target processing entities may be implemented based on a machine learning model. For example, the electronic device 110 may provide the interactive control information obtained via the input control 335 to the target model to instruct the target model to manage an interaction process of the plurality of interactive objects in the interactive scene in accordance with the content described by the interactive control information.

In some embodiments, the electronic device 110 may also provide a debug window 350 in the configuration interface 300A. As an example, the debug window 350 may include a portal 355 for initiating debugging based on current application configuration information.

In some embodiments, the debug window 350 may present a conversation interface engaged by the plurality of interactive objects (e.g., configured processing entities and/or user objects) corresponding to a plurality of predetermined roles. The conversation interface may display interactive messages generated by the plurality of interactive objects in the interactive scene.

Continuing with the debate scenario as an example, the host role may generate an opening message based on the scene description information and/or the interactive control information. Further, the predetermined processing entity corresponding to each debater role may generate a corresponding message accordingly, for example, according to the scene description information and the context information in the dialog. Accordingly, when a viewpoint is required to be recognized by a user object, the electronic device 110 may provide a corresponding message input control to support the user to input a corresponding interactive message.

At block 220, the electronic device 110 creates a target application based on the application configuration information.

By way of example, the electronic device 110 can create a corresponding target application based on the application configuration information. Further, the target application can be published or shared to other users, for example. As an example, the electronic device 110 may receive a user selection of the publishing control 360 to accordingly create and publish the target application corresponding to the received application configuration information.

Based on the described process, the embodiments of the present disclosure can support a target control entity to manage an interaction process in a target interactive scene by calling a workflow, thereby improving the management efficiency of the interaction process and reducing the development cost for an application.

### Example Apparatus and Device

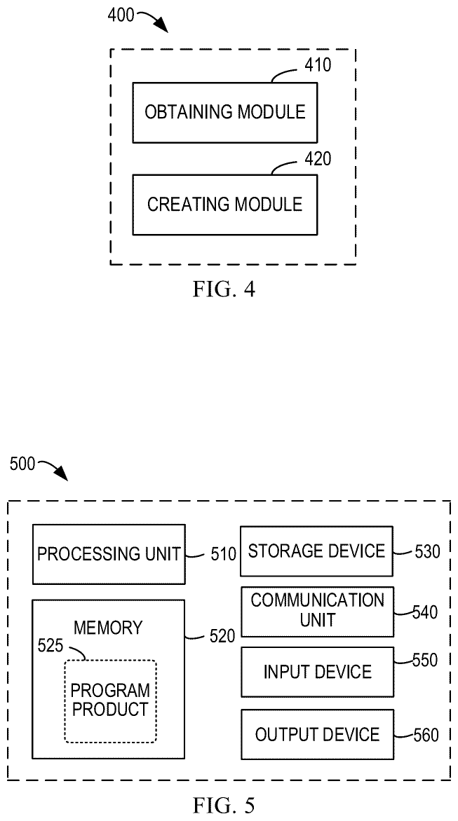

Embodiments of the present disclosure also provide corresponding apparatus for implementing methods or processes described above. FIG. 4 illustrates a schematic structural block diagram of an example apparatus 400 for creating an application in accordance with certain embodiments of the present disclosure. The apparatus 400 may be implemented as or included in the electronic device 110. The various modules/components in the apparatus 400 may be implemented by hardware, software, firmware, or any combination thereof.

As shown in FIG. 4, the apparatus 400 includes an obtaining module 410 configured to obtain application configuration information, the application configuration information including interactive control information about a target interactive scene, where the interactive control information is configured to construct a target processing entity corresponding to the target interactive scene, such that the target processing entity manages, based on the interactive control information, an interaction process for a set of interactive objects participating in the target interactive scene, and the interactive control information indicating at least one workflow associated with the target processing entity; and a creating module 420 configured to create a target application based on the application configuration information.

In some embodiments, the at least one workflow includes a first workflow, and the obtaining module 410 is further configured to: in response to receiving a viewing request, present a set of candidate workflows associated with the target interactive scene; and receive a selection of a first workflow of the set of candidate workflows.

In some embodiments, the at least one workflow includes a second workflow, and the obtaining module 410 is further configured to: in response to receiving a creating request, present a workflow creation page; and create a second workflow using the workflow creation page.

In some embodiments, the at least one workflow includes a dialog node for creating a speaking task, the speaking task being configured to trigger at least one speaker to provide a corresponding message in the target interactive scene.

In some embodiments, the obtaining module 410 is further configured to obtain, via the dialog node, identity configuration information corresponding to the at least one speaker, the identity configuration information including at least one of: a role of the speaker; a nickname of the speaker; an identity variable defined in the workflow, the identity variable indicating at least one interactive object in the set of interactive objects.

In some embodiments, the obtaining module 410 is further configured to obtain, via the dialogue node, message configuration information corresponding to the at least one speaker, the message configuration information indicating content of a target message provided by the at least one speaker.

In some embodiments, the message configuration information indicates a message providing mode of the at least one speaker, the message providing mode including: a first providing mode indicating that the at least one speaker generates the target message; or a second providing mode for indicating the at least one speaker to provide the target message configured via the dialog node.

In some embodiments, the at least one speaker includes a plurality of speakers, and the obtaining module 410 is further configured to determine, via the dialog node, a sequential mode for the plurality of speakers, the sequential mode indicating the order of speaking of the plurality of speakers.

In some embodiments, the sequential mode includes: a first sequential mode indicating that the plurality of speakers speak sequentially according to a target sequence configured through the dialog node; a second sequential mode indicating that the plurality of speakers speak according to a random sequence; or a third sequential mode indicating that the plurality of speakers speak in parallel.

In some embodiments, the apparatus 400 further includes an adjusting module configured to, in response to the sequential mode being the first sequential mode, adjust a display sequence of a plurality of content items corresponding to the plurality of speakers in the dialog node based on a received configuration operation, to determine the target sequence.

In some embodiments, the obtaining module 410 is further configured to determine, via the dialog node, a visible range for the message provided by the at least one speaker.

In some embodiments, the dialog node is configured to output first content according to a first format, the first content including at least one of: a role of the at least one speaker; an identifier of the at least one speaker; and message content provided by the at least one speaker.

In some embodiments, at least one workflow includes a start node, the start node is configured to output second content according to a second format, the second content is configured for describing the set of interactive objects in the target interactive scene.

In some embodiments, the at least one workflow includes a termination node configured to generate a control message for terminating the target interactive scene.

In some embodiments, the application configuration information further includes role configuration information, the role configuration information indicating a set of predetermined roles associated with the target interactive scene.

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 may be used to implement the electronic device 110 of FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communications units 540, one or more input devices 550, and one or more output devices 560. The processing unit 510 may be an actual or virtual processor and can perform various processes according to programs stored in the memory 520. In a multiprocessor system, a plurality of processing units execute computer executable instructions in parallel, so as to improve the parallel processing capability of the electronic device 500.

The electronic device 500 typically includes a number of computer storage media. Such media may be any available media that are accessible by electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium such as a flash drive, a magnetic disk, or any other medium that can be used to store information and/or data and that can be accessed within the electronic device 500.

The electronic device 500 may further include additional removable/non-removable, volatile/nonvolatile storage media. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Thus, the electronic device 500 may operate in a networked environment using logical connections to one or more other servers, network personal computers (PCs), or another network node.

The input device 550 may be one or more input devices such as a mouse, keyboard, trackball, etc. The output device 560 may be one or more output devices such as a display, speaker, printer, etc. The electronic device 500 may also communicate with one or more external devices (not shown) such as a storage device, a display device, or the like through the communication unit 540 as required, and communicate with one or more devices that enable a user to interact with the electronic device 500, or communicate with any device (e.g., a network card, a modem, or the like) that enables the electronic device 500 to communicate with one or more other electronic devices. Such communication may be performed via an input/output (I/O) interface (not shown).

According to an exemplary implementation of the present disclosure, a computer readable storage medium is provided, on which a computer-executable instruction is stored, where the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for creating an application, comprising:
obtaining application configuration information, the application configuration information comprising interactive control information about a target interactive scene, wherein the interactive control information is configured to construct a target processing entity corresponding to the target interactive scene such that the target processing entity manages, based on the interactive control information, an interaction process for a set of interactive objects participating in the target interactive scene, and wherein the interactive control information indicates at least one workflow associated with the target processing entity; and
creating a target application based on the application configuration information.

2. The method of claim 1, wherein the at least one workflow comprises a first workflow, and obtaining the application configuration information comprises:
in response to receiving a viewing request, presenting a set of candidate workflows associated with the target interactive scene; and
receiving a selection of the first workflow in the set of candidate workflows.

3. The method of claim 1, wherein the at least one workflow comprises a second workflow and obtaining the application configuration information comprises:
in response to receiving a creating request, presenting a workflow creation page; and
creating the second workflow using the workflow creation page.

4. The method of claim 1, wherein the at least one workflow comprises a dialog node for creating a speaking task, the speaking task being configured to trigger at least one speaker to provide a corresponding message in the target interactive scene.

5. The method of claim 4, wherein obtaining the application configuration information comprises:
obtaining, via the dialog node, identity configuration information corresponding to the at least one speaker, the identity configuration information comprising at least one of:
a role of the speaker;
a nickname of the speaker; or
an identity variable defined in the workflow, the identity variable indicating at least one interactive object in the set of interactive objects.

6. The method of claim 4, wherein obtaining the application configuration information comprises:
obtaining, via the dialog node, message configuration information corresponding to the at least one speaker, the message configuration information indicating content of a target message provided by the at least one speaker.

7. The method of claim 6, wherein the message configuration information indicates a message providing mode for the at least one speaker, the message providing mode comprising:
a first providing mode indicating that the at least one speaker generates the target message; or
a second providing mode indicating that the at least one speaker provides the target message configured via the dialog node.

8. The method according to claim 4, wherein the at least one speaker comprises a plurality of speakers, and obtaining the application configuration information comprises:
determining, via the dialog node, a sequential mode for the plurality of speakers, the sequential mode indicating a speaking sequence for the plurality of speakers.

9. The method of claim 8, wherein the sequential mode comprises:
a first sequential mode indicating that the plurality of speakers speak sequentially according to a target sequence configured through the dialog node;
a second sequential mode indicating that the plurality of speakers speak according to a random sequence; or
a third sequential mode indicating that the plurality of speakers speak in parallel.

10. The method of claim 9, further comprising:
in response to the sequential mode being the first sequential mode, adjusting a display sequence of a plurality of content items corresponding to the plurality of speakers in the dialog node based on a received configuration operation, to determine the target sequence.

11. The method according to claim 4, wherein obtaining the application configuration information comprises:
determining, via the dialog node, a visible range for the message provided by the at least one speaker.

12. The method of claim 4, wherein the dialog node is configured to output first content according to a first format, the first content comprising at least one of:
a role of the at least one speaker;
an identifier of the at least one speaker; or
message content provided by the at least one speaker.

13. The method of claim 1, wherein the at least one workflow comprises a start node configured to output second content in a second format, the second content describing the set of interactive objects in the target interactive scene.

14. The method of claim 1, wherein the at least one workflow comprises a termination node configured to generate a control message for terminating the target interactive scene.

15. The method of claim 1, wherein the application configuration information further comprises role configuration information, the role configuration information indicating a set of predetermined roles associated with the target interactive scene.

16. An electronic device, comprising:
at least one processing unit; and
at least one memory, the at least one memory being coupled to the at least one processing unit and storing instructions for execution by the at least one processing unit, the instructions, when executed by the at least one processing unit, cause the electronic device to:
obtain application configuration information, the application configuration information comprising interactive control information about a target interactive scene, wherein the interactive control information is configured to construct a target processing entity corresponding to the target interactive scene, such that the target processing entity manages, based on the interactive control information, an interaction process for a set of interactive objects participating in the target interactive scene, and wherein the interactive control information indicates at least one workflow associated with the target processing entity; and
create a target application based on the application configuration information.

17. The electronic device of claim 16, wherein the at least one workflow comprises a first workflow and the electronic device is further caused to:
in response to receiving a viewing request, present a set of candidate workflows associated with the target interactive scene; and
receive a selection of the first workflow in the set of candidate workflows.

18. The electronic device of claim 16, wherein the at least one workflow comprises a second workflow and the electronic device is further caused to:
in response to receiving a creating request, present a workflow creation page; and
create the second workflow using the workflow creation page.

19. The electronic device of claim 16, wherein the at least one workflow comprises a dialog node for creating a speaking task, the speaking task being configured to trigger at least one speaker to provide a corresponding message in the target interactive scene.

20. A non-transitory computer readable storage medium, on which a computer program is stored, wherein the computer program is executable by a processor to implement a method for creating an application, comprising:
obtaining application configuration information, the application configuration information comprising interactive control information about a target interactive scene, wherein the interactive control information is configured to construct a target processing entity corresponding to the target interactive scene, such that the target processing entity manages, based on the interactive control information, an interaction process for a set of interactive objects participating in the target interactive scene, and wherein the interactive control information indicates at least one workflow associated with the target processing entity; and
creating a target application based on the application configuration information.
